(19) United States
(12) Patent Application Publication
(10) Pub. No.: US 2010/0079375 A1
(43) Pub. Date: Apr. 1, 2010

(54) Mouse and its method with shortcut code output functions

(76) Inventor: Kuei-Lin Chung, Taipei (TW)

Correspondence Address: BACON & THOMAS, PLLC, 625 SLATERS LANE, FOURTH FLOOR, ALEXANDRIA, VA, 22314-1176, US

(21) Appl. No.: 12/379,014

(22) Filed: Feb. 11, 2009

(30) Foreign Application Priority Data
Sep. 30, 2008 (TW) 097137506

(51) Int. Cl. G09G 5/08

(52) U.S. Cl. 345/163

(57) ABSTRACT

The present invention discloses a mouse and its method with shortcut code output functions; the mouse is predefined or added with a shortcut code output key; the mouse is provided with a control module, which transmits the displacement and shift data of the mouse to the computer system, allowing the cursor to generate equivalent and isotropic shift; the control module is provided internally with a shortcut code output module, which sets different shortcut codes' analog codes according to the shift direction of mouse. This method comprises the following steps: the control module judges if the shortcut code output key generates signals.

### FIELD OF THE INVENTION

The present invention relates generally to a mouse and its method with shortcut code output functions.

### BACKGROUND OF THE INVENTION

In a computer framework, the keyboard and mouse, etc, play a crucial role in the interaction with the computer system. Referring to FIG. 1, any individual with computer knowledge can understand how to operate the keyboard (K) and computer system (PC) through the following steps:

Step 1: when a user presses any key on the keyboard (K), an electric circuit in the keyboard generates a signal specific to the key (different signals are defined by the keys on the keyboard);

Step 2: when the aforementioned signals are detected by the microprocessor C on the keyboard, a corresponding scan code will be generated and then stored temporarily in the buffer zone of the mainboard M;

Step 3: BIOS on the mainboard M reads the scan code, converts into a code, and stores in RAM for data processing by the central processor;

Step 4: the central processor reads the internal code, and implements the character functions specific to the internal code (implementation behavior or character displayed on the screen).

As shown, any signal generated by pressing a key will be finally converted by BIOS into a specific internal code; the coding principle of the internal code depends much on universal UNICODE code (international standard code).

The internal code is aimed at converting the identifiable characters into binary codes that can be accessed by central processor, e.g.: if pressing SPACE button, BIOS will convert the characters into U+0020; after being accessed and identified by the central processor CPU, an empty character string will be generated on the screen; if pressing numeric key 0, BIOS will convert them into U+0030; after being accessed and identified by the central processor, a character 0 will be generated on the screen;

As for the graphic characters of UNICODE code, a character symbol will be generated at the cursor point after entry; in addition, a control character is also defined for UNICODE code. The difference between the control character and graphic character lies in: the control character is not displayed on the screen, but the computer is controlled to implement a certain action or command, for example: shift of direction key, delete characters with DEL or ESC; as aforementioned keys are converted by BIOS according to UNICODE code, the worldwide keyboards are provided with keys that can generate control characters.

With rapid development and integration of applications, the defined control characters of previous keyboard could not answer the complex requirements of most of the applications. Today, the designed applications are defined with the shortcut key that enables the users to operate the programs conveniently with self-developed behaviors or functions.

Referring to FIG. 2, shortcut keys means pressing function keys (e.g.: CTRL, SHIFT or FN) in collaboration with other keys could control the window or implement a specific behavior similar to the functions of control character; these keys are mainly defined in applications in the same manner as the central processor and keyboard; the applications with shortcut key functions shall be provided with a shortcut key T, which is loaded into the computer system simultaneously with the application. Referring to FIG. 2, when a user presses down the shortcut key, such a key will generate scan code, which is compiled by BIOS into UNICODE code and accessed by the central processor. In such case, the central processor outputs the command corresponding to the shortcut key TABLE preset by the application, for example: if pressing Ctrl+N in the EXCEL application, the command of new files will be generated by the coding procedure and shortcut key TABLE, so the user likely memorizes the common functions or the activated shortcut keys.

However, the shortcut key is designed for the applications on web-based browsing and file processing, etc. While this keyboard is frequently used, the shortcut key enables more convenient operation by the user with least use of the mouse and without need of shifting the hands from the keyboard; but, this is not suitable for image compilation and graphics software with different operating practices, owing to the fact that the compilation with such type of software often relies on mouse, namely, the mouse is shifted and operated to click the functional icons on the screen, without pressing manually two or more function keys.

In view of the shortcomings of the present existing storage devices with an inconvenient way of expanding their storage capacity, the inventor of the present invention based on years of experience in the related industry to conduct extensive researches and experiments, and finally developed a dynamic, convenient, safe and efficient way of expanding the storage capacity to overcome the shortcomings of the prior art.

### SUMMARY OF THE INVENTION

The primary objective of the present invention is to provide a mouse and its method with shortcut code output functions; this mouse is predefined or added with a shortcut code output key; also, this mouse is provided with a control module, which transmits the displacement and shift data of the mouse to the computer system, allowing the cursor to generate equivalent and isotropic shift; and this control module is provided with a shortcut code output module, which presets different shortcut codes' analog codes according to the shift direction of mouse. This method comprises the following steps:

(1) the control module judges if the shortcut code output key generates signals;

(2) in the absence of signals, the displacement and shift data of the mouse are transmitted to the computer system, allowing the cursor to generate equivalent and isotropic shift;

(3) otherwise, the signal shortcut code's output module transmits shortcut code's analog code to the computer system according to the shift direction of the mouse.

In this way, the above-specified method can combine the shortcut key's functions with the mouse, enabling the user to control the cursor and send the shortcut code by holding a mouse.

According to aforementioned characteristics, the mouse is provided at least with left, right and scroll buttons; the shortcut code output key is defined as one or two keys of common mouse, or any additional fourth mouse key.

According to aforementioned characteristics, the major function of the shortcut code output key of the present invention is to decide if the data output by the computer system is mouse's shift data or shortcut code.

One objective of the present invention is to provide a mouse with shortcut code output functions, which comprising:

(1) a mouse, which is provided at least with left, right and scroll buttons; and also provided with an optical module for detecting its shift data;

(2) a control module, which is used to transmit the mouse's shift data detected by the optical module to the computer system;

(3) a shortcut code output module, which can send different shortcut analog codes according to the mouse's shift information of the control module; and

(4) a shortcut code output key, which is set on the mouse, and used to decide if the data output by the computer system is mouse's shift data or shortcut simulation code.

To make it easier for our examiner to understand the technical characteristics and effects of the present invention, we use preferred embodiments with accompanying drawings for the detailed description of the present invention as follows.

### BRIEF DESCRIPTION OF THE DRAWINGS

FIG. 1 is an operational chart of previous input device and computer system;

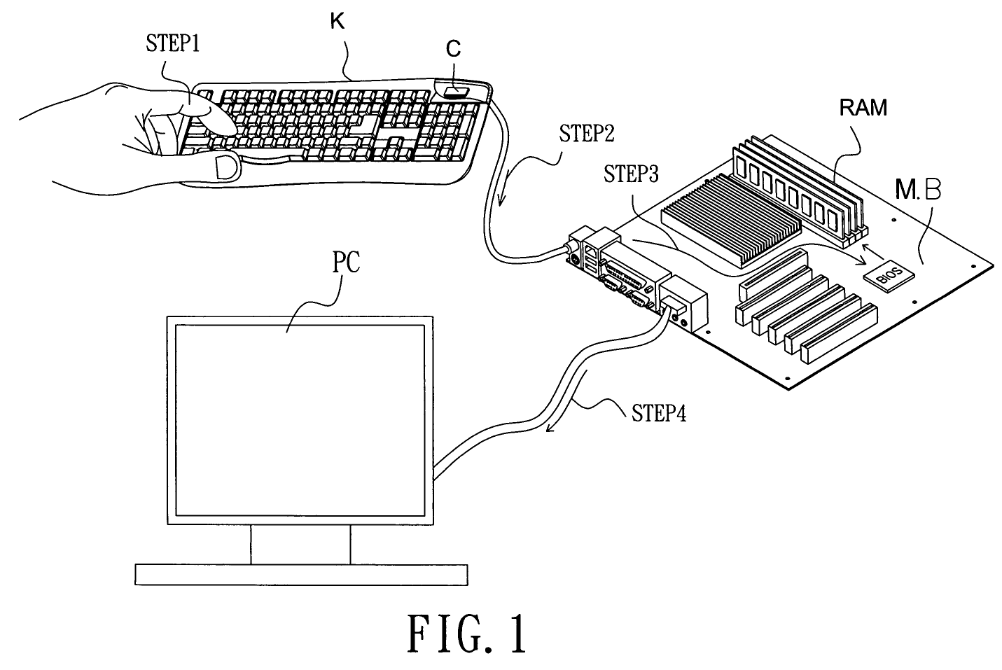

FIG. 2 is a flow process chart of previous input device and computer system;

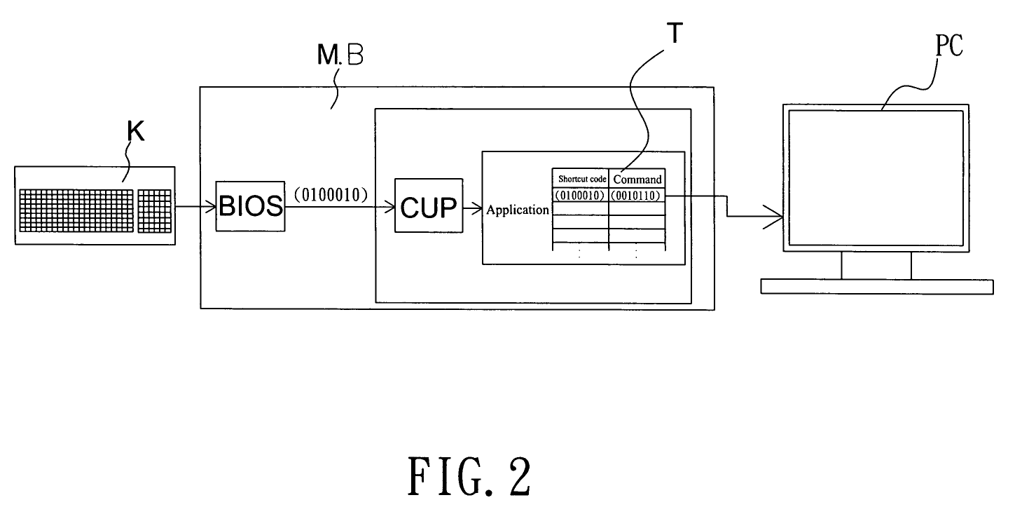

FIG. 3 is a connection chart of the modules specific to the mouse of the present invention with shortcut code output functions;

FIG. 4 is a methodology chart of the shortcut code output functions of the present invention;

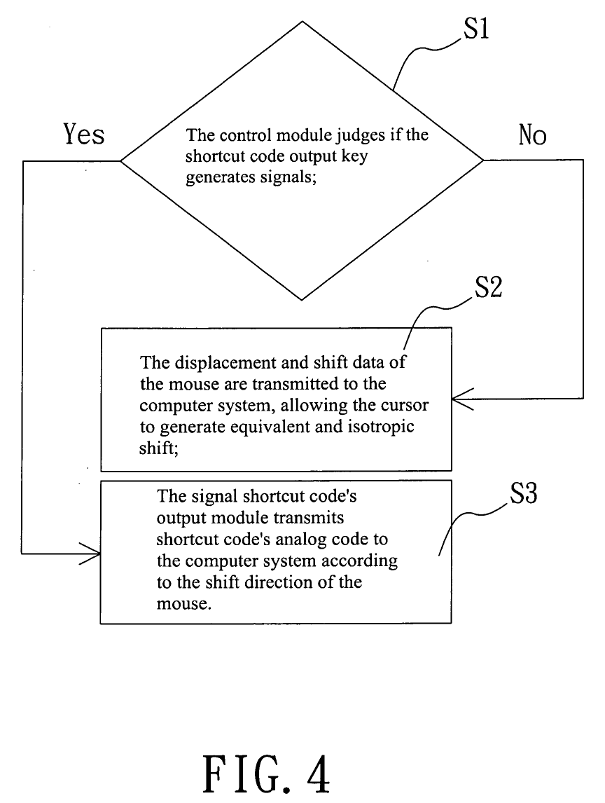

FIG. 5 is a schematic view of the present invention as to how the mouse with shortcut code output functions is operated.

### DESCRIPTION OF THE PREFERRED EMBODIMENTS

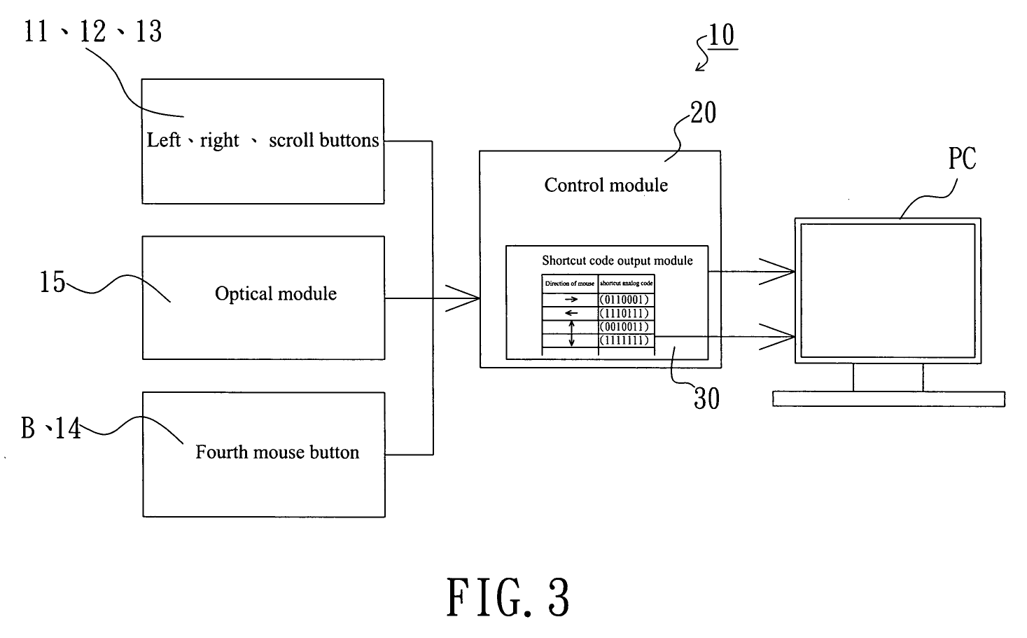

Referring to these figures, the present invention provides a shortcut code output method for the mouse 10, which is predefined or added with a shortcut code output key B. Generally speaking, the mouse 10 is provided at least with left button 11, right button 12 and scroll button 13, or a fourth button 14; an optical module 15 is placed at lower end of the mouse 10 to provide shift data; the mouse 10 is provided internally with a control module 20, which transmits the above-specified shift data and keying signals to a computer system (PC), allowing the cursor to generate equivalent and isotropic shift (shown in FIG. 3); the shortcut code output key B defined in the present invention may be any one or two buttons on the mouse 10, or even fourth mouse button 14; the control module 20 is provided internally with a shortcut code output module 30, which presets different shortcut codes' simulation codes according to the shift direction of mouse 10, permitting the mouse 10 to output the same shortcut codes like a typical keyboard.

Referring to FIGS. 3˜4, when the present invention is put into operation, the predefined shortcut code output key B decides if the data output by the computer system (PC) is mouse's shift data or shortcut code's analog code (fourth mouse button of the preferred embodiment is defined as a shortcut code output key B); firstly, the control module 20 of the mouse 10 judges if the predefined shortcut code output key B generates signals (S1); if not, the control module 20 will transmits the displacement and shift direction of the mouse 10 to the computer system(PC) for further processing, allowing the cursor to generate equivalent and isotropic shift (same with common mouse 10) (S2); if yes, the signal shortcut code's output module 30 transmits shortcut code's analog code to the computer system (PC) according to the shift direction of the mouse 10 (S3).

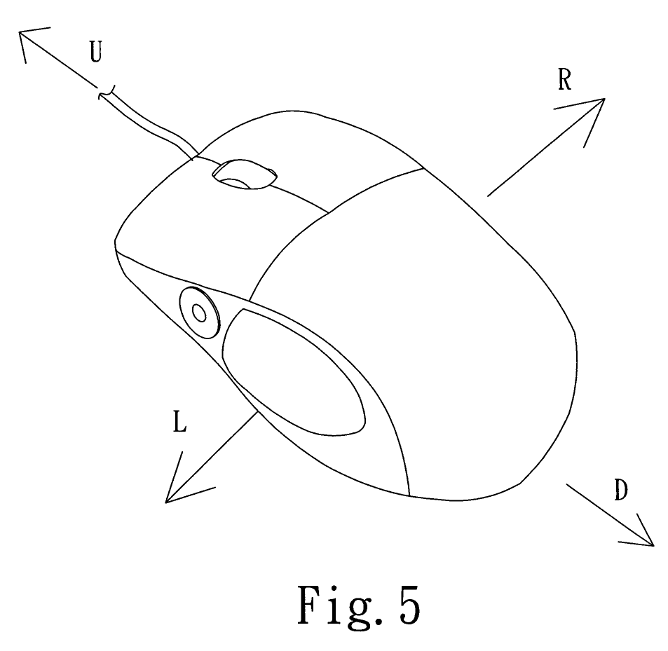

Referring to FIG. 5—a schematic view of the present invention as to how the mouse with shortcut code output functions is operated.

If the shortcut code output module 30 of the mouse 10 is set by the shift direction of the mouse 10, the computer system (PC) sends CTRL+P(opening print-up dialogue window) shortcut code's simulation code when the mouse 10 shifts leftwards, or sends F5(searching and replacement character window) shortcut code's simulation code when the mouse 10 shifts rightwards; or sends CTRL+O(opening file selection window)shortcut code's simulation code when the mouse 10 shifts upwards; or sends CTRL+N(opening file selection window) shortcut code's analog code when the mouse 10 shifts downwards. In addition, the predefined fourth mouse button is shortcut code output key B; when the mouse 10 is under common state (i.e. shortcut code output key B not pressed), the mouse control module transmits the displacement and shift data of the mouse 10 to the computer system (PC), allowing the cursor to generate equivalent and isotropic shift; when the shortcut code is to be sent off, it's only required to press the predefined shortcut code output key B and shift the mouse 10, enabling the shortcut code output module 30 to send the preset shortcut code's analog code according to the shift direction of the mouse 10, for example: when the user presses the shortcut key's output key and moves the mouse 10 downwards, the shortcut code output module 30 of the mouse 10 sends CTRL+N(opening file selection window) shortcut code's analog code to the computer system (PC) according to aforementioned settings; when the user presses the shortcut keys' output key B and moves the mouse 10 upwards, the shortcut code output module 30 of the mouse 10 sends CTRL+O(opening file selection window) shortcut code's simulation code to the computer system (PC).

The shortcut code's analog code sent to the computer system (PC) by shortcut code output module 30 is a universal UNICODE, or ASCII, IS08859, EBCDIC or BIG5 code, depending on the environment code of the computer system.

While the invention has been described by means of specific embodiments, numerous modifications and variations could be made thereto by those skilled in the art without departing from the scope and spirit of the invention set forth in the claims.

What is claimed is:

1. A method with shortcut code output functions, wherein the mouse is predefined or added with a shortcut code output key; this mouse is provided with a control module, which transmits the displacement and shift data of the mouse to the computer system, allowing for shift of the cursor on the screen; the control module is provided with a shortcut code output module, which sets different shortcut codes' analog codes according to the shift direction of mouse; it comprises the following steps:
the control module judges if the shortcut code output key generates signals;
in the absence of signals, the displacement and shift data of the mouse are transmitted to the computer system, allowing the cursor to generate equivalent and isotropic shift;
otherwise, the signal shortcut code's output module transmits shortcut code's analog code to the computer system according to the shift direction of the mouse.

2. The method with shortcut code output functions according to claim 1, wherein the mouse is provided at least with left, right and scroll buttons; and the shortcut code output key is defined as one or two keys of common mouse.

3. The method with shortcut code output functions according to claim 1, wherein the mouse is added exclusively with a shortcut code output key.

4. The method with shortcut code output functions according to claim 1, wherein the shortcut code output key decides if the data output by the computer system is mouse's shift data or shortcut code.

5. A mouse with shortcut code output functions, for entering the computer system, which comprising:
a mouse, which is provided at least with left, right and scroll buttons;
and also provided with an optical module for detecting its shift data;
a shortcut code output key, which is set on the mouse;
a control module, which is used to transmit the mouse's shift data detected by the optical module to the computer system; and
a shortcut code output module, which can send different shortcut analog codes according to the mouse's shift information of the control module.

6. The mouse with shortcut code output functions according to claim 5, wherein the mouse is provided at least with left, right and scroll buttons; the shortcut code output key is defined as one or two keys of common mouse.

7. The mouse with shortcut code output functions according to claim 5, wherein the mouse is added exclusively with a shortcut code output key.

8. The mouse with shortcut code output functions according to claim 5, wherein the shortcut code output key decides if the data output by the computer system is mouse's shift data or shortcut simulation code.
